(19) United States
(12) Patent Application Publication
(10) Pub. No.: US 2006/0165324 A1
(43) Pub. Date: Jul. 27, 2006

(54) Hybrid dynamic pressure bearing of spindle motor

(75) Inventor: Sang-Uk Kim, Seoul (KR)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(73) Assignee: G&W Technologies Corporation

(21) Appl. No.: 10/516,574

(22) PCT Filed: Jun. 4, 2003
(86) PCT No.: PCT/KR03/01098

§ 371 Date: Jul. 13, 2005

(30) Foreign Application Priority Data
Jun. 4, 2002 (KR) 10-2002-0031221

(51) Int. Cl. F16C 32/06

(52) U.S. Cl. 384/107

(57) ABSTRACT

The present invention relates to a bearing of a spindle motor for a hard disk drive which includes an aero dynamic pressure bearing which is fixedly installed in a space formed by a base and hub, a fluid dynamic pressure bearing which rotatably pivots the center of a in a radical direction and a thrust direction, and an air groove formed in such a manner that a certain space is formed between the hub and the aero dynamic pressure bearing after the hub is driven, wherein the aero dynamic pressure bearing and the fluid dynamic pressure bearing are directed to forming an upper side plane of which an upper side is extended in an outer radical direction like a spinning top for thereby implementing a conical shape in which a width of a lower side is decreased in a vertical direction.

### TECHNICAL FIELD

The present invention relates to a spindle motor for a hard disk drive (HDD), and in particular to a hybrid dynamic pressure bearing system of a spindle motor for a hard disk derive which is capable of preventing a noise and operation error by maintaining a desired rotation center without a mechanical contact of an aero dynamic pressure bearing when a spindle motor is rotated, in such a manner that a spindle motor is supported in a radial and thrust direction based on an aero dynamic pressure bearing and fluid dynamic pressure bearing in a spindle motor for a hard disk drive.

### BACKGROUND ART

Generally, a hard disk drive (HDD) for a computer system includes a platter which is a metallic circular plate coated with a magnetic material for recording a certain data thereon, a head which has a function for reading and writing a data in a platter, a head arm connected in order for the head to move a certain data address, a circuit substrate, and a spindle motor. The hard disk drive is directed to an apparatus for reading and reproducing a data stored in the platter through the head and recording a new data onto the platter. A plurality of platters are inserted into a hub and are rotated, and a shaft adapted to rotate the hub is connected with a spindle motor. Here, the head arm is called as an actuator which is driven by a voice coil motor (VCM).

The conventional spindle motor will be described.

FIG. 1 is a perspective view illustrating a hard disk spindle motor having a ball bearing adaptation structure in the conventional art. FIG. 2 is a vertical cross sectional view.

As shown in FIGS. 1 and 2, a spindle motor 10 for a hard disk drive of a ball bearing structure in a conventional art includes a base 11 which forms a lower constriction of the system, a spindle shaft 12 which is installed vertically to the center of the base 11, a lower ball bearing 13 which is installed in a lower outer portion of the spindle shaft 12, a stator 14 which is installed in an outer portion of the lower ball bearing 13 in a shape that a coil 14b is wound on a core 14a, an upper ball bearing 15 which is installed in an upper portion of the spindle shaft 12, a hub 16 which is rotatably supported by the outer surfaces of the upper and lower ball bearings 13 and 14 in a shape that the hub 16 covers the upper sides of the base 11, and a ring shaped permanent magnet 17 which is installed in an inner surface of the lower side of the hub 16 and generates a driving force by which the hub 16 is rotated based on a magnetic field formed between the coil 14b.

In the spindle motor 19 for a hard disk drive, when a power is applied to the coil 14b of the stator 14, a magnetic field (not shown) is formed between the coil 14b and the permanent magnet 17, and the hub 16 is rotated in a certain direction by the magnetic field. In the operation that the hub 16 is rotated, the upper and lower ball bearings 13 and 15 may no operate at a high speed due to the defects of themselves and or an external impact based on a high accuracy.

In a high speed operation, the ball bearings 13 and 15 may generate a noise and vibration.

The construction of the aero dynamic pressure bearing will be described with reference to the vertical cross sectional view which illustrates a spindle motor for a hard disk of FIG. 3.

As shown in FIG. 3, the hard disk spindle motor 20 includes a base 21 which forms a lower construction, a lower bearing 22 which is installed in an upper side of the center of the base 21, a stator 23 which is installed in an outer side of the lower bearing 22 which is an upper portion of the base 21 in a construction that a coil 23b is wound on a core 23a, a spindle shaft 24 which is vertically installed in an upper center portion of the lower bearing 22, an upper bearing 25 which is installed in an upper portion of the spindle motor 24, a hub 26 which is rotatably supported by an outer portion of the spindle motor 24 in a state that the sub 26 covers the upper portion of the base 21, an upper first aero dynamic pressure bearing 27 and a lower second aero dynamic pressure bearing 28 which are installed in the inner upper portion of the hub 26 and form an aero dynamic pressure based on a rotation of the hub 26 with respect to the spindle shaft 24, and a permanent magnet 29 which is installed in a lower inner surface of the hub 26 for thereby forming a magnetic field between the coils 23b and generates a driving force by which the hub 26 is rotated.

In the hard disk spindle motor 20, when a power is applied to the coil 23b, a magnetic field (not shown) is generated between the coil 23b and the permanent magnet 29. The hub 26 is rotated in a certain direction by a magnetic field between the coil 23b and the permanent magnet 29. When the hub 29 is rotated, a certain aero flow occurs in the inner surfaces of the first and second aero dynamic pressure bearings 27 and 28. As the rotation of the hub 26 is increased, an aero flow forms a stronger aero layer in proportion to the revolution of the hub 26 between the first and second aero dynamic pressure bearings 27 and 28, the spindle shaft 24, the upper bearing 25, and the lower bearing 22. Therefore, the spindle motor 20 is rotated about the spindle shaft 24, overcoming a load amount and external impact which are applied to the hub 26 which is a rotational member of the hard disk spindle motor using the air layer as a bearing having a certain strength formed between the spindle shaft 24.

However, the hand disk spindle motor of the dynamic pressure bearing adaptation structure is capable of enhancing a strength of the air layer up to a certain fixed rate, but the revolution of the same exceeds a certain revolution, the strength of the air layer is not increased in proportion to the increased revolution, maintaining a constant value.

The conventional hard disk spindle motor 20 has a structure capable of maintaining a certain gap with respect to the dynamic pressure bearing in such a manner that the base, the lower bearing, the spindle shaft and the upper bearing are assembled. In the above assembled structure, in the case that the spindle shaft and other bearings are assembled, the productivity is decreased, and it is impossible to maintain a constant thickness of the air layer or gap.

Furthermore, even when the hard disk spindle motor has a desired rated speed, since an air layer having a large strength is formed between the hub and the aero dynamic pressure bearing, it is impossible to obtain a discharging path of a static electricity which occurs in the peripheral portions of the hub and platter, so that an error may occur during the data reading and writing operations. In other words, since the conventional hard disk spindle motor 20 is constructed in such a manner that the hub contacts with an upper portion of the spindle motor in a boundary of the air layer not by certain direct contact method, an operation error may occur due to a friction during the operation and stop, and a certain friction, noise and vibration may occur between the hub and the bearings.

### DISCLOSURE OF INVENTION

Accordingly, it is a first object of the present invention to provide a hybrid dynamic pressure bearing of a spindle motor which is capable of supporting a spindle motor in a radial direction and thrust direction through a fluid dynamic pressure bearing which directly contacts with a center of a hub, and an aero dynamic pressure bearing having a groove receives a radial and thrust weight of the hub by a non-contact method, so that it is possible to implement a rotational center without a mechanical contact of a dynamic pressure bearing.

It is a second object of the present invention to provide a hybrid dynamic pressure bearing of a spindle motor which is capable of implementing a rotation accuracy by increasing a certain rotation strength of a bearing and implementing a stable rotation without inclination when a spindle motor rotates at a low speed or a high speed in such a manner that at least one groove is formed in a portion among an upper horizontal surface of a bearing assembly, a lower horizontal surface and a bearing assembly outer surface of an aero dynamic pressure bearing, a lower horizontal surface and inner surface of a hub, and an inner surface of a bushing thrust.

It is a third object of the present invention to provide a hybrid dynamic pressure bearing of a spindle motor which is capable of implementing a discharging of a static electricity by filling a certain fluid such as an oil into a pore between a spindle shaft and a sleeve of a fluid dynamic pressure bearing when a static electricity occurs due to an air based on a high speed operation and a friction between a hub and a platter and is capable of protecting a data stored and enhancing a stability of a motor based on a contact type rotation support structure through a fluid dynamic pressure bearing.

To achieve the above objects, in a spindle motor for a hard disk drive(HDD), there is provided an aero and fluid hybrid dynamic pressure bearing of a spindle motor, comprising an aero dynamic pressure bearing which is formed in a structure that there are provided a disk shaped bearing assembly,

and a certain pore surrounding the bearing assembly and which includes a plurality of grooves and forms an air layer having a certain strength so that an air flow supports a load between a hub and the bearing assembly after the hub is operated, and a fluid dynamic pressure bearing which is formed in a structure that a plurality of grooves are formed in at least one surface among a spindle shaft, a sleeve surrounding the spindle shaft, and a thrust plate and which has a pore formed between the spindle shaft and the sleeve for rotatably supporting the hub and filled with a certain fluid.

In another embodiment of the present invention, in order to achieve the above objects, in a spindle motor for a hard disk drive which includes a base which forms a lower construction, a hub which is rotatably installed in an upper portion of the base and fixes a platter in an upper surface, and has a permanent magnet in an inner lower surface, and a stator which has a plurality of teeth having a coil wound thereon and protruded in a direction of an outer surface for thereby forming a radial construction, there is provided a fluid and air hybrid dynamic pressure bearing, comprising an aero dynamic pressure bearing which is formed in a structure that there are provided a disk shaped bearing assembly, and a certain pore surrounding the bearing assembly and which includes a plurality of grooves and forms an air layer having a certain strength so that an air flow supports a load between a hub and the bearing assembly after the hub is operated; a fluid dynamic pressure bearing which is formed in a structure that a plurality of grooves are formed in at least one surface among a spindle shaft, a sleeve surrounding the spindle shaft, and a thrust plate and which has a pore formed between the spindle shaft and the sleeve for rotatably supporting the hub and filled with a certain fluid ; and a bushing thrust provided between the fluid dynamic pressure bearing, a ring shaped permanent magnet, a back yoke which supports the permanent magnet, a bearing assembly of the aero dynamic pressure bearing and the stator.

In further another embodiment of the present invention, in a spindle motor for a hard disk drive which includes a base which forms a lower construction, a hub which is rotatably installed in an upper portion of the base and fixes a platter in an upper surface, and has a permanent magnet in an inner lower surface, and a stator which has a plurality of teeth having a coil wound thereon and protruded in a direction of an outer surface for thereby forming a radial construction, there is provided a fluid and air hybrid dynamic pressure bearing, comprising an aero dynamic pressure bearing which is formed in a structure that there are provided a disk shaped bearing assembly, and a certain pore surrounding the bearing assembly and which includes a plurality of grooves and forms an air layer having a certain strength so that an air flow supports a load between a hub and the bearing assembly after the hub is operated; a fluid dynamic pressure bearing which is implemented in a structure that a plurality of grooves are formed in at least one surface in the spindle shaft, a sleeve surrounding the same, and a thrust plate, and a certain fluid for a discharging path of a static electricity is filled in a pore formed between the spindle shaft and the sleeve for rotatably supporting the hub and forming a fluid dynamic pressure between the spindle shaft; and a bushing thrust which is implemented in a structure that the fluid dynamic pressure bearing is fixed with respect to the spindle shaft formed in an upper portion of the hub and in which the fluid dynamic pressure bearing is fixed about the hub shaft which passes through one end formed in a vertical direction of the interior, the busing thrust being provided between the ring shaped permanent magnet, a back yoke supporting the permanent magnet, a bearing assembly of the aero dynamic pressure bearing and the stator.

In still further another embodiment of the present invention, in a bearing of a spindle motor for a hard disk drive which includes a base which forms a lower construction, a hub which is rotatably installed in an upper portion of the base and fixes a platter, and a stator in which a plurality of teeth each having a coil are protruded in a direction of an outer surface in a radial shape, there is provided a hybrid dynamic pressure bearing of a spindle motor, comprising an aero dynamic pressure bearing which includes a bearing assembly formed in a disk shape and forming an upper construction, and a support member which is integrally formed with a lower portion of the bearing assembly and is compression-fixed to the base and which is installed in a space formed by the base and the hub; an aero dynamic pressure bearing which forms an air layer having a certain strength for supporting a load of an air flow between the hub and the bearing assembly after the hub is operated, in such a manner that a groove is formed in at least one surface among an upper horizontal surface and a lower horizontal surface of the bearing assembly of the aero dynamic pressure bearing, a lower horizontal surface of the hub, an integral inner surface of the hub, and an inner surface of the bushing thrust; and a fluid dynamic pressure bearing which obtains a static electricity path by filling a certain fluid such as an oil having a certain viscosity with respect to a static electricity generated in a peripheral portion of the hub and platter and which has an inner construction of a spherical shape, a semi-circular shape, a conical shape or a cylindrical shape, the fluid dynamic pressure bearing supporting the center of the hub in the radial direction and thrust direction.

Still further another embodiment of the present invention, in a spindle motor for a hard disk drive which includes a base which forms a lower construction, a hub which is rotatably installed in an upper portion of the base and fixes a platter in an upper surface, and has a permanent magnet in an inner lower surface, and a stator which has a plurality of teeth having a coil wound thereon and protruded in a direction of an outer surface for thereby forming a radial construction, there is provided a fluid and air hybrid dynamic pressure bearing, comprising an aero dynamic pressure bearing which is formed in a structure that there are provided a disk shaped bearing assembly, and a certain pore surrounding the bearing assembly and which includes a plurality of grooves and forms an air layer having a certain strength so that an air flow supports a load between a hub and the bearing assembly after the hub is operated; a fluid dynamic pressure bearing which is implemented in a structure that a plurality of grooves are formed in at least one surface among a spindle shaft, a sleeve surrounding the spindle shaft, and a thrust plate, wherein rotation and support point are fixed at a center which passes through the interior in a vertical direction, and a fluid for a discharging path of a static electricity is filled in a port formed between the spindle shaft and the sleeve for rotatably supporting the hub and forming a fluid dynamic pressure between the spindle shaft; and a bushing thrust which is implemented in a structure that the fluid dynamic pressure bearing is fixed with respect to the spindle shaft formed in an upper portion of the hub and in which the fluid dynamic pressure bearing is fixed about the hub shaft which passes through one end formed in a vertical direction of the interior, the busing thrust being provided between the ring shaped permanent magnet, a back yoke supporting the permanent magnet, a bearing assembly of the aero dynamic pressure bearing and the stator.

### BRIEF DESCRIPTION OF THE DRAWINGS

The present invention will become better understood with reference to the accompanying drawings which are given only by way of illustration and thus are not limitative of the present invention, wherein;

FIG. 1 is a disassembled perspective view illustrating a hard disk spindle motor of a ball bearing adaptation structure in a conventional art;

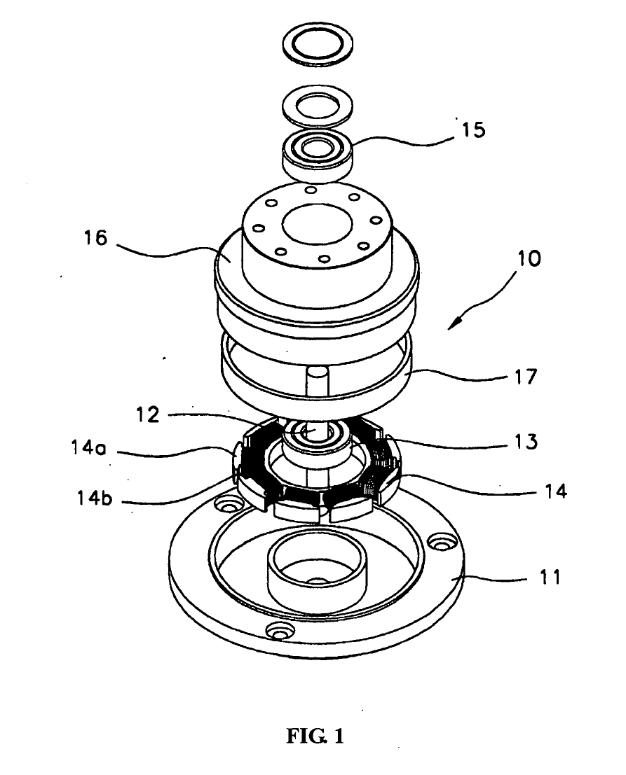

FIG. 2 is a vertical cross sectional view of FIG. 1;

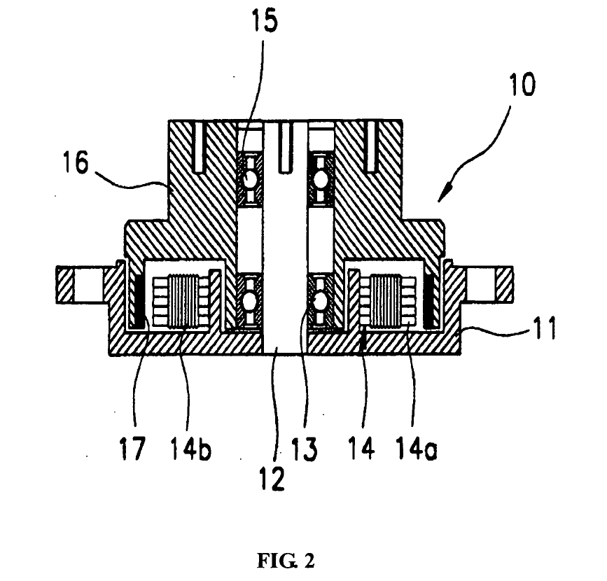

FIG. 3 is a vertical cross sectional view illustrating a hard disk spindle motor of a dynamic pressure bearing adaptation structure in a conventional art;

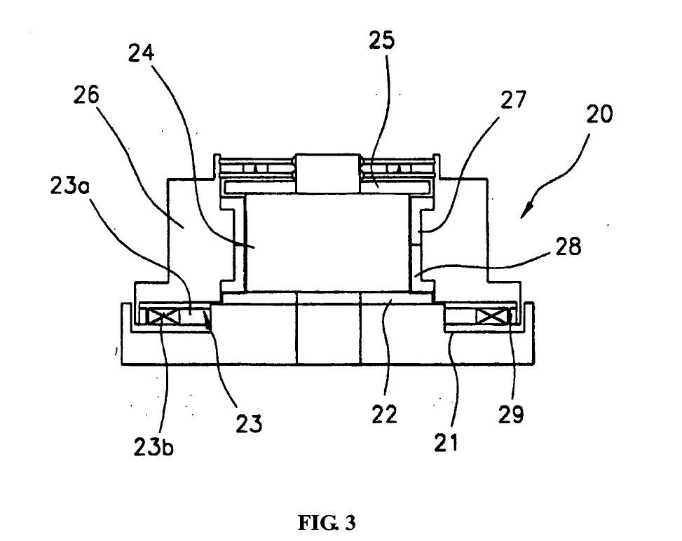

FIG. 4 is a disassembled perspective view illustrating a hybrid spindle motor of a spindle motor having a bushing thrust according to a first embodiment of the present invention;

FIG. 5 is an engaged cross sectional view illustrating a partial engaged state in a hybrid spindle motor of FIG. 4;

FIG. 6 is a disassembled perspective view when a spindle shaft is rotated in a hybrid bearing of a hard disk drive spindle motor according to a second embodiment of the present invention;

FIG. 7 is a cross sectional view when a spindle shaft is rotated in a hybrid bearing of a hard disk drive spindle motor according to a second embodiment of the present invention;

FIG. 8 is a disassembled perspective view when a spindle shaft is fixed, and there is a bushing thrust in a hybrid bearing of a hard disk drive spindle motor according to a third embodiment of the present invention;

FIG. 9 is a cross sectional view when a spindle shaft is fixed, and there is a bushing thrust in a hybrid bearing of a hard disk drive spindle motor according to a third embodiment of the present invention;

FIG. 10 is a disassembled perspective view when a spindle shaft is fixed in a hybrid bearing of a hard disk drive spindle motor according to a fourth embodiment of the present invention;

FIG. 11 is a cross sectional view when a spindle shaft is fixed in a hybrid bearing of a hard disk drive spindle motor according to a fourth embodiment of the present invention;

FIG. 12 is a disassembled perspective view when there is a bushing thrust, a spindle shaft is fixed to a bearing assembly and is extended to an outer portion of a hub in a hybrid bearing of a hard disk drive spindle motor according to a fifth embodiment of the present invention;

FIG. 13 is a cross sectional view when there is a bushing thrust, a spindle shaft is fixed to a bearing assembly and is extended to an outer portion of a hub in a hybrid bearing of a hard disk drive spindle motor according to a fifth embodiment of the present invention;

FIG. 14 is a disassembled perspective view when a spindle shaft is fixed to a bearing assembly and is extended in a direction of an outer portion of a hub in a hybrid bearing of a hard disk drive spindle motor according to a sixth embodiment of the present invention;

FIG. 15 is a cross sectional view when a spindle shaft is fixed to a bearing assembly and is extended in a direction of an outer portion of a hub in a hybrid bearing of a hard disk drive spindle motor according to a sixth embodiment of the present invention;

FIG. 16 is a cross sectional view when an aero dynamic pressure bearing and a fluid dynamic pressure bearing are separately fabricated and then are assembled to a hub and a bearing assembly in a hybrid bearing of a hard disk drive spindle motor according to a seventh embodiment of the present invention;

FIG. 17 is a cross sectional view when an aero dynamic pressure bearing is separately fabricated and then is assembled to a hub, and a sleeve operates as a bearing assembly of an aero dynamic pressure bearing in a hybrid bearing of a hard disk drive spindle motor according to an eighth embodiment of the present invention; and

FIG. 18 is a cross sectional view when an aero dynamic pressure bearing is integral with a hub, and a sleeve operates as a bearing assembly of an aero dynamic pressure bearing in a hybrid bearing of a hard disk drive spindle motor according to a ninth embodiment of the present invention.

### BEST MODE FOR CARRYING OUT THE INVENTION

The preferred embodiments of the present invention will be described with reference to the accompanying drawings.

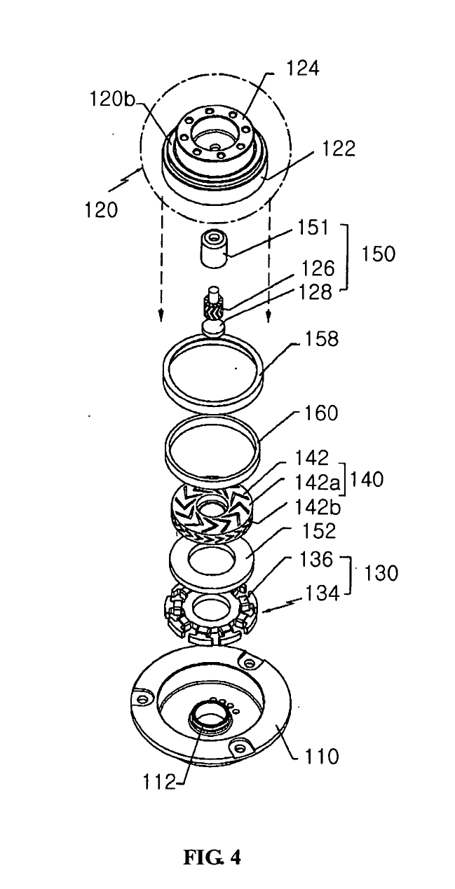

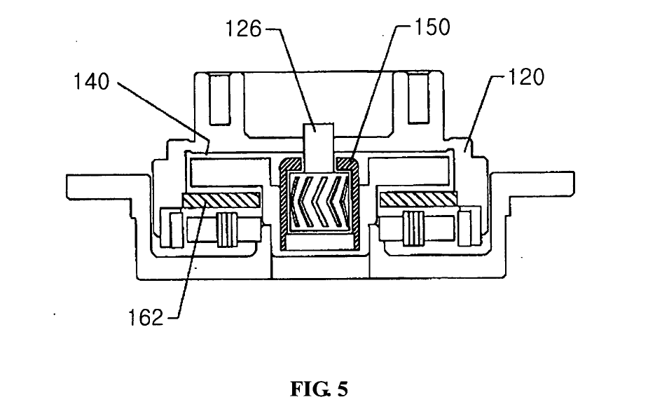

The hybrid dynamic pressure bearing of a spindle motor according to a first embodiment of the present invention will be described with reference to FIGS. 4 and 5.

FIG. 4 is a disassembled perspective view illustrating a hybrid spindle motor of a spindle motor having a bushing thrust according to a first embodiment of the present invention, and FIG. 5 is an engaged cross sectional view illustrating a partial engaged state in a hybrid spindle motor of FIG. 4.

As shown in FIGS. 4 and 5, the hybrid spindle motor 100 of a spindle motor according to the present invention includes a base 110 which forms a lower structure of the same, a hub 120 which includes a metallic circular platter (not shown) rotatably installed on an upper portion of the base 110, a stator 130 which has a compression insertion hole in a center portion of the same and is constructed in such a manner that a coil 136 is wound in each of multiple cores 134 which are formed in an outer surface of the compression insertion hole at a regular interval, an aero dynamic pressure bearing 140, a fluid dynamic pressure bearing 150, a spindle shaft 126 adapted to support a weight of the hub 120, a ring shaped permanent magnet 160, a back yoke 158 adapted to support the permanent magnet 160, and a bushing thrust 162 provided between the bearing assembly 142 and the stator 130.

As shown in FIGS. 4 and 5, the base 110 is constructed in such a manner that the base 110 is provided in a lower portion of the spindle motor 100 and is formed in a concentric accommodating groove 112 in which a concentric upper side is opened in the upper surface which is belonged to the base 110 of the spindle motor 100. In addition, in the base 110, there are provided a stator 130 and an aero dynamic pressure bearing 140 in a space formed by the lower surface of the hub 120 which is rotatably installed and the accommodating groove 112.

In addition, the hub 120 includes an integral body 122 provided in a lower portion corresponding to an inner surface of the base 110, a platter fixture 124 which is integrally provided in an upper portion of the integral body 122 and engages a platter (not shown) which is a magnetic disk, and a layer 120b provided between the integral body 122 and the platter fixture 124. At this time, an outer diameter of the integral body 122 is smaller than an inner surface of the base 110, and an inner diameter of the integral body 122 is larger than an outer diameter of the bearing assembly 142 of the aero dynamic pressure bearing 140. In addition, the hub 120 is installed in such a manner that there is not a mechanical contact between an outer surface of the integral body 122 and an inner surface of the base 110 and an upper surface of the bearing assembly 142 and an inner surface of the integral body 122 and an outer surface of the bearing assembly 142 of the aero dynamic pressure bearing 140. In addition, the hub 120 includes a first air groove 124a (not shown) formed in a lower inner cross section of the same, a second air groove 124b formed in a radial direction of the inner surface, and a third air groove 124c formed in an inner surface of the bushing thrust.

The stator 130 is fixedly provided in a space formed by the accommodating groove 112 of the base 110 and the integral body 122 of the hub 120.

In addition, the aero dynamic pressure bearing 140 includes a bearing assembly 142 which forms a dynamic pressure in a lower inner portion of the hub 120, a support member 144 which is integrally formed in a lower portion of the bearing assembly 142 and is fixed to the base 110, and air grooves 142a, 142b and 142c.

In the aero dynamic pressure bearing 140 of the hybrid spindle motor 100, when the hub 120 is rotated at a high speed, a dynamic pressure is formed between the hub 120 and the bearing assembly 142 of the aero dynamic pressure bearing 140.

The fluid dynamic pressure bearing 150 includes a thrust plate 128 in which a spindle shaft 126 assembled to the hug 120 is rotatably supported from the lower side about its rotational center, and a sleeve 151. In addition, the fluid dynamic pressure bearing 150 rotatably supports the spindle shaft 126 which is the center of the rotation of the hub 120 in the center of the aero dynamic pressure bearing 140, and there is provided a thrust plate 128 for preventing a leakage of the fluid and supporting a weight in a thrust direction. In the fluid dynamic pressure bearing 150, a certain fluid having a viscosity like an oil is filled between the sleeve 151 and the spindle shaft 126, so that it is possible to obtain a discharging path of a static electricity when a static electricity occurs in the hub 120 and the platter. The center of the hub 120 is supported in the radial direction and thrust direction.

The fluid dynamic pressure bearing 150 is fixed about the center of the spindle shaft 126 of the hub 120 which passes through one end formed in a vertical direction of the interior of the same.

In addition, the permanent magnet 160 is installed in an inner surface of the hub 120 neighboring with the core 134 on which the coil 136 of the stator 130 is wound. Here, the permanent magnet 160 is formed in a ring shape and includes a back yoke 158 in an outer surface of the same. The outer diameter of the permanent magnet 160 corresponds to the inner diameter of the integral body 122 of the hub 120. Therefore, the permanent magnet 160 is fixed to an inner surface of the integral body 122 of the hub 120 corresponding to the core 134 of the stator 130.

The operation of the hybrid spindle motor 100 according to a first embodiment of the present invention will be described with reference to FIGS. 4 and 5.

In the hybrid spindle motor 100 according to the present invention, since the fluid dynamic pressure bearing 150 supports the center of the hub 120 in a radial direction and thrust direction, the spindle motor 100 does not have a mechanical contact between the hub 120 and the aero dynamic pressure bearing assembly 142 based on the rotation of the hub 120 when the spindle motor 100 is operated at an initial stage or is stopped. Therefore, in the hybrid spindle motor 100, it is possible to maintain a rotational center and to implement a desired rotation without any noise and operation error due to a mechanical contact.

In addition, in the aero dynamic pressure bearing 140 of the hybrid spindle motor 100, a dynamic pressure occurs between the hub 120 and the bearing assembly 142 of the aero dynamic pressure bearing 140 when the hub 120 is rotated at a high speed. Therefore, the thrust and radial load of the hub 120 which is rotated at a high speed are obtained based on the non-contact of the hub 120 and the bearing assembly 142.

In the hybrid spindle motor 100 according to a first embodiment of the present invention, when a power is applied to the spindle motor 100, a magnetic field is formed between the core 134 on which the coil 136 of the stator 130 is wound and the permanent magnet 160, and the hub 120 of the spindle motor 100 is rotated with respect to the spindle shaft 126 as a rotational center. When the hub 120 is rotated in the above manner, an aero layer is formed between the aero dynamic pressure bearing 140 and the hub 120, and a fluid layer is formed between the spindle shaft 126 and the spindle shaft 126. Therefore, the fluid dynamic pressure bearing 150 and the aero dynamic pressure bearing 140 are provided with the divided thrust and radial loads in a non-contact state between the air layer and the fluid layer.

The center of the hub 120 is connected with the spindle shaft 126. In addition, an aero dynamic pressure bearing is formed in the lower portion of the hub 120 based on a first air groove 124a, a second air groove 124b in an inner surface radial direction, and a third air groove 124c of an inner surface of a bushing thrust 162 (FIGS. 4 and 5).

When a power is applied, in the stator 130, a magnetic field (not shown) is formed between the permanent magnet 160 for thereby generating a driving force by which the hub 120 is rotated in a certain direction. The stator 130 includes a plurality of cores 134 formed in a radial direction at a regular interval, and a coil 136 for converting the core 134 into an electric magnet when a power is applied to the outer surface of the core 134 and forming a magnetic field between the permanent magnet 160.

The aero dynamic pressure bearing 140 is in stalled in a space formed by the base 110 and the hub 120 for thereby forming an aero dynamic pressure between the lower surface of the hub 120 when the hub 120 is rotated. In addition, in the case that the aero dynamic pressure bearing 140 is fixedly supported by the accommodating groove 112 of the base 110 through the support member 144, a compression insertion hole (not shown) formed in the circumferential center portion of the stator 130 is fixedly accommodated in the center of the accommodating groove 112.

As shown in FIG. 5, the air grooves 142a, 142b, and 142c formed in the bearing assembly 142 of the aero dynamic pressure bearing 140 may be formed in the upper horizontal surface of the bearing assembly 1432 in a concentric shape. Here, the air groove may be in a certain shape.

The fluid dynamic pressure bearing 150 supports the spindle motor 126 of the hub 120 in a radial direction and thrust direction through the fluid dynamic pressure bearing 150 for supporting the center of the hub 120. Therefore, in the present invention, a mechanical contact which may be a cause of a noise and operation error due to the rotation of the hub 120 does not occur when the spindle motor 100 operates at an initial stage or stops.

Namely, when the spindle motor 100 operates at an initial stage or stops, the spindle shaft 126 of the hub 120 is supported in a radial and thrust direction through the fluid dynamic pressure bearing 150, so that it is possible to prevent a mechanical contact between the hub 120 and the aero dynamic pressure bearing assembly 142 which may be a cause of a noise and operation error due to a rotation of the hub 120. Therefore, it is possible to implement a stable rotational center of the hub 120.

In addition, the aero dynamic pressure bearing 140 and the fluid dynamic pressure bearing 150 generates a dynamic pressure between the aero dynamic pressure bearing assembly 142 and the air grooves 142a, 142b and 142c when the spindle motor 100 is rotated at a high speed, so that the aero dynamic pressure bearing 140 supports almost thrust and radial loads of the hub 120.

Therefore, it is possible to implement an excellent rotational accuracy by enhancing a rotational strength of the spindle shaft 126 with respect to an external impact and an ability by which the hub 120 is not inclined but stably rotated.

In the spindle motor 100 according to a first embodiment of the present invention, when the spindle motor 120 is operated, stopped and rotated at a low speed, the spindle shaft 126 of the hub 120 is supported in a radial direction and thrust direction, so that a radial and thrust weight of the hub 120 are received. When the hub 120 is rotated at a high speed, the radial and thrust weights of the hub 120 are almost supported by the aero dynamic pressure bearing 140, so that the thrust and radial weights of the hub 120 that the spindle shaft 126 receives are small, so that it is possible to implement a high speed rotation.

In addition, the permanent magnet 160 generates a driving force for rotating the hub 120 based on a magnetic field formed between the coils 136 of the stator 130 when a power is applied. The permanent magnet 160 is installed in an inner surface of the hub 120 near the core 134 on which the COIL 136 IS wound for thereby forming a magnetic field between the coils 136.

The permanent magnet 160 is installed in an inner surface of the hub 120, and the ring shaped permanent magnet 160 generates a driving force for rotating the hub 120 based on a magnetic field formed between the coil 136.

Therefore, the permanent magnet 160 is fixed to the back yoke 158 and is fixedly installed in the inner surface of the integral body 122 of the hub 120.

Therefore, when a power is applied to the coil 136 of the stator 130, a magnetic field is generated between the coils 160, so that the hub 120 is rotated in a certain direction.

In the spindle motor 100 for a hard disk drive according to a first embodiment of the present invention, when the hub 120 is operated, stopped or rotated at a low speed, the weights of the hub 120 in the radial direction and thrust direction are supported based on the fluid dynamic pressure bearing 150, so that it is possible to prevent a mechanical contact between the hub 120 and the aero dynamic pressure bearing assembly 142 which may be a cause of a noise and operation error due to the rotation of the hub 120. In a high speed rotation mode, a dynamic pressure is formed between the aero dynamic pressure bearing assembly 142 and the hub 120o through the air grooves 142a, 142b and 142c of the aero dynamic pressure bearing 140, so that almost thrust and radial weights of the hub 120 are supported by the aero dynamic pressure bearing 140. Therefore, it is possible to implement a desired rotation strength of the fluid dynamic pressure bearing 150 with respect to an external impact and to prevent the hub 120 from being inclined, so that it is possible to maintain an excellent rotation accuracy.

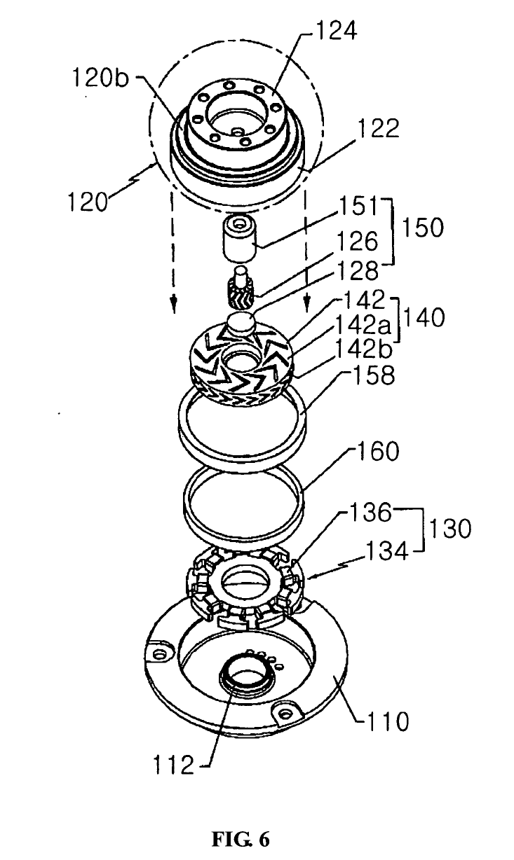

Preferably, the present invention may be implemented in another embodiment. Other embodiments of the present invention will be described with reference to FIGS. 6 through 18 will be described. In the following detailed description of the present invention, the same elements as the first embodiment of FIG. 4 will be given the same reference numerals. The duplicated descriptions and reference numerals may be omitted for a simplification of the description.

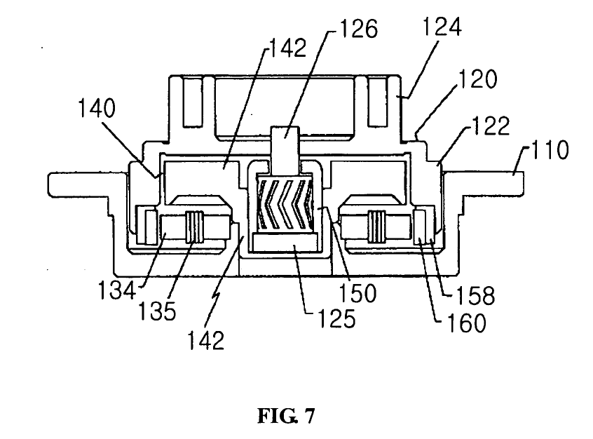

FIG. 6 is a disassembled perspective view when a spindle shaft is rotated in a hybrid bearing of a hard disk drive spindle motor according to a second embodiment of the present invention, and FIG. 7 is a cross sectional view when a spindle shaft is rotated in a hybrid bearing of a hard disk drive spindle motor according to a second embodiment of the present invention.

In the hybrid spindle motor 100 according to the second embodiment of the present invention, a fluid dynamic pressure bearing 150 and an aero dynamic pressure bearing 140 are combined. As shown in FIGS. 6 and 7, the hybrid spindle motor 100 according to the second embodiment of the present invention includes a base 110 which forms a lower construction of the same, a hub 120 which is rotatably installed in an upper portion of the base 110 and includes a metallic circular platter (not shown), a stator 130 which has a compression insertion hole in a center portion of the same and is constructed in such a manner that a coil 136 is wound on each of multiple cores 134 which are formed in an outer surface of the compression insertion hole at a regular interval, an aero dynamic pressure bearing 140, a fluid dynamic pressure bearing 150, a spindle shaft 126 for supporting the weight of the hub 120, a ring shape permanent magnet 160, and a back yoke 158 for supporting the permanent magnet 160.

Here, the base 110 is positioned in a lower portion of the spindle motor 100. An accommodating groove 112 having a certain depth is formed in a certain concentric space in the upper surface belong to the base 110 of the spindle motor 100. Namely, the base 110 is formed in a concentric structure in which an upper side of the same is opened. In addition, in the above base 110, the stator 130 and the aero dynamic pressure bearing 140 are installed in a space formed by the lower surface of the hub 120 which is rotatably installed and the accommodating groove 112.

In addition, the hub 120 is rotated by a magnetic field formed between the coil 136 of the stator 130 and the permanent magnet 160 and includes an integral body 122 which is provided in a portion corresponding to an inner surface of the base 110, and a platter fixture 124 which is integrally installed in an upper portion of the integral body 122 and is directed to engaging a platter (not shown) which is a magnetic disk. The outer diameter of the integral body 122 is smaller than the inner surface of the base 110, and the inner diameter of the integral body 122 is larger than the outer diameter of the bearing assembly 142 of the aero dynamic pressure bearing 140. The hub 120 is installed in such a manner that a mechanical contact does not occur between the outer surface of the integral body 122 and the inner surface of the base 110 and the upper surface of the bearing assembly 142, and the inner surface of the integral body 122 and the outer surface of the bearing assembly 142 of the aero dynamic pressure bearing 140. In addition, the hub 120 forms a first air groove 124a (not shown) in a lower inner side cross section surface, and a second air groove 124b in a radial direction in the inner surface.

The stator 130 is fixedly installed in a space formed by the accommodating groove 112 of the base 110 and the integral body 122 of the hub 120.

When the aero dynamic pressure bearing 140 is fixed by the accommodating groove 112 of the base 110 through the support member 144, the compression insertion hole of the stator 130 is fixedly accommodated in the center of the accommodating groove 112. The diameter of the bearing assembly 142 of the aero dynamic pressure bearing 140 is smaller than the inner diameter of the integral body 122 of the hub 120 and does not contact with the inner surface of the integral body 122 of the hub 120. In addition, the horizontal surface of the upper portion of the bearing assembly 142 of the aero dynamic pressure bearing 140 does not contact with the lower surface of the integral body 122 of the hub 120.

In addition, the aero dynamic pressure bearing 140 includes a bearing assembly 142 which forms a dynamic pressure in a lower inner side of the hub 120, a support member 144 which is integrally formed in a lower portion of the bearing assembly 142 and is fixed to the base 110, and air grooves 142a and 142b.

The fluid dynamic pressure bearing 150 includes a thrust plate 128 in which the spindle shaft 126 assembled to the hub 120 is rotatably supported at its lower portion in the center of the rotation, and a sleeve 151. In addition, the fluid dynamic pressure bearing 150 rotatably installs the spindle shaft 126 which is a rotation center of the hub 120 in the center of the aero dynamic pressure bearing 140. In addition, there is provided a thrust plate 128 for preventing a leakage of the fluid and supporting the load in a thrust direction. In addition, in the fluid dynamic pressure bearing 150, a certain fluid having a viscosity like an oil is filled between the sleeve 151 and the spindle shaft 126. Therefore, when a static electricity occurs in the hub 120 and the platter, a certain discharging path of the static electricity is implemented, and the center of the hub 120 is supported in the radial direction and thrust direction.

The fluid dynamic pressure bearing 150 passes through one end in the vertical direction in the interior of the same and is fixed with respect to the spindle shaft 126 of the hub 120. Therefore, in the hybrid dynamic pressure bearing of the spindle motor, the fluid dynamic pressure bearing 150 forms a fluid dynamic pressure between the sleeve 151 and the spindle shaft 126.

The permanent magnet 160 is installed in an inner surface of the hub 120 near the core 134 on which the coil 136 of the stator 130 is wound. The permanent magnet 160 is formed in a ring shape, and the back yoke 158 is installed in an outer surface of the same. The outer diameter of the same is determined based on the inner diameter of the integral body 122 of the hub 120.

Therefore, the permanent magnet 160 is fixed in an inner surface of the hub 120 corresponding to the core 134 of the stator 130.

The operation of the hybrid spindle motor 100 according to a second embodiment of the present invention will be described with reference to FIGS. 6 and 7.

In the hybrid spindle motor 100 according to the present invention, the fluid dynamic pressure bearing 150 supports the center of the hub 120 in a radial direction and thrust direction, so that a mechanical contact does not occur between the hub 120 and the aero dynamic pressure bearing assembly 142 when the hub 120 is rotate in the case that the spindle motor 100 is operated at an initial stage or is stopped. Therefore, the hybrid spindle motor 100 maintains a stable rotation center and is rotated without any noise and operation error which may occur due to a mechanical contact.

In the hybrid spindle motor 100 according to a second embodiment of the present invention, when a power is applied to the spindle motor 100, a magnetic field is formed between the core 134 on which the coil 136 of the stator 130 is wound and the permanent magnet 160, so that the hub 120 of the spindle motor 100 is rotated with respect to the rotation center of the spindle shaft 126. When the hub 120 is rotated in the above manner, an air layer is formed between the aero dynamic pressure bearing 140 and the hub 120, and a fluid layer is formed between the spindle shaft 126 and the sleeve 151. Therefore, the fluid dynamic pressure bearing 150 and the aero dynamic pressure bearing 140 are provided with the divided thrust and radial weights in a non-contact state based on the air layer and the fluid layer.

The center of the hub 120 is connected with the spindle shaft 126. There are provided a first air groove 124a in a lower surface of the hub 120 and a second air groove 124b in a radial direction in an inner surface.

As a power is applied, the stator 130 forms a magnetic field (not shown) between the permanent magnet 160, so that a driving force is generated for thereby rotating the hub 120 in a certain direction. The stator 130 has a compression insertion hole in the upper and lower portions of the same and includes a plurality of cores 134 which are integral with respect to the outer surface of the same and are formed at a regular integral in a radial shape, and a coil 136 which is wound on an outer surface of each core 134 and forms a magnetic field between the permanent magnet 160 by changing each core 134 into an electric magnet.

The aero dynamic pressure bearing 140 is installed in a space formed by the base 110 and the hub 120 and forms an aero dynamic pressure between the lower surface of the hub 120 when the hub 120 is rotated. In addition, the aero dynamic pressure bearing 140 includes a disk shaped bearing assembly 142 which forms an aero dynamic pressure between a lower horizontal surface and an inner surface of the hub 120 in such a manner that an air groove 142a having a certain depth is formed in an upper horizontal surface of the bearing assembly 142, and a support member 144 which is integrally formed in the lower portion of the bearing member 142 and is fixed in the accommodating groove 112 of the base 110 through the compression insertion hole of the stator 130 in a space formed by the base 110 and the hub 120.

In the aero dynamic pressure bearing 140 of the hybrid spindle motor 100, a dynamic pressure is formed between the hub 120 and the bearing assembly 142 of the aero dynamic pressure bearing 140 when the hub 120 is rotated at a high speed. Therefore, the spindle motor 100 receives a certain thrust and radial load of the hub 120 which is rotated at a high speed based on a non-contact between the hub 120 and the bearing assembly 142.

As shown in FIG. 7, the air grooves 142a and 142b formed in the bearing assembly 142 of the aero dynamic pressure bearing 140 may be formed in the concentric shape on the upper horizontal surface of the bearing assembly 142. Here, the construction of the groove shape is not limited thereto.

Various construction of the same may be implemented.

The fluid dynamic pressure bearing 150 supports the spindle shaft 126 of the hub 120 in the radial direction and thrust direction through the fluid dynamic pressure bearing 150 for supporting the center of the hub 120, so that it is possible to prevent a mechanical contact between the hub 120 and the bearing assembly 142 which may be a cause of a noise and an operation error during a rotation of the hub 120 when the spindle motor 100 is operated at an initial stage and is stopped. Namely, when the spindle motor 100 is operated at an initial stage or stopped, the spindle shaft 126 of the hub 120 is supported in the radial direction and thrust direction based on the fluid dynamic pressure bearing 150, so that it is possible to prevent a mechanical contact between the hub 120 and the aero dynamic pressure bearing assembly 142 which may be a cause of a noise and operation error during a rotation of the hub 120.

In addition, in the aero dynamic pressure bearing 140 and the fluid dynamic pressure bearing 150, when the spindle motor 100 is rotated at a high speed, a dynamic pressure is formed between the aero dynamic pressure bearing assembly 142 and the hub 120 through the air grooves 142a and 142b of the aero dynamic pressure bearing assembly 142, so that almost loads in the thrust and radial directions of the hub 120 are supported by the aero dynamic pressure bearing 140. Therefore, it is possible to implement a desired rotation strength of the spindle shaft 126 with respect to an external impact and to prevent the hub 120 from being inclined for thereby obtaining an excellent rotation accuracy.

In the spindle motor 100 according to a second embodiment of the present invention in which the aero dynamic pressure bearing 140 and the fluid dynamic pressure bearing 150 are adapted, when the hub 120 is operated at an initial stage, stopped and is rotated at a low speed, the spindle shaft 126 of the hub 120 is supported in the radial and thrust directions by the fluid dynamic pressure bearing 150 and receives a radial and thrust direction load of the hub 120. In a high speed rotation mode, almost thrust loads of the hub 120 is supported by the aero dynamic pressure bearing 140, so that the thrust and radial direction loads of the hub 120 applied to the spindle shaft 126 are small, whereby it is possible to implement a high speed rotation.

When a power is applied, the permanent magnet 160 generates a driving force for rotating the hub 120 based on a magnetic field between the coil 136 of the stator 130, and the permanent magnet 160 is installed in an inner surface of the hub 120 near the core 134 on which the coil 136 of the stator 130 is wound for thereby forming a magnetic field between the coils 136.

As the permanent magnet 160 is installed in an inner surface of the hub 120, the permanent magnet 160 generates a driving force which is adapted to rotate the hub 120 based on a magnetic field formed between the coils 136.

Therefore, the permanent magnet 160 is fixed to the back yoke 158 and is fixedly installed in an inner surface of the integral body 122 of the hub 120.

When a power is applied to the coil 136 of the stator 130, a magnetic field is generated between the permanent magnet 160, so that the hub 120 is rotated in a certain direction.

In the spindle motor 100 for a hard disk drive according to a second embodiment of the present invention, when the hub 120 is operated, stopped or is rotated at a low speed, the loads of the thrust and radial directions of the hub 120 are supported by the fluid dynamic pressure bearing 150, so that it is possible to prevent a mechanical contact between the hub 120 and the aero dynamic pressure bearing assembly 142 which may be a cause of a noise and operation error when the hub 120 is rotated. In the high speed operation mode, a dynamic pressure is formed between the aero dynamic pressure bearing member 142 and the hub 120 based on the air grooves 142a and 142b of the aero dynamic pressure bearing 140, so that almost loads in the thrust and radial directions of the hub 120 are supported by the aero dynamic pressure bearing 140. Therefore, it is possible to implement a desired rotation strength of the fluid dynamic pressure bearing 150 and prevent the hub 120 from being inclined when the hub 120 is rotated, for thereby implementing an excellent rotation accuracy.

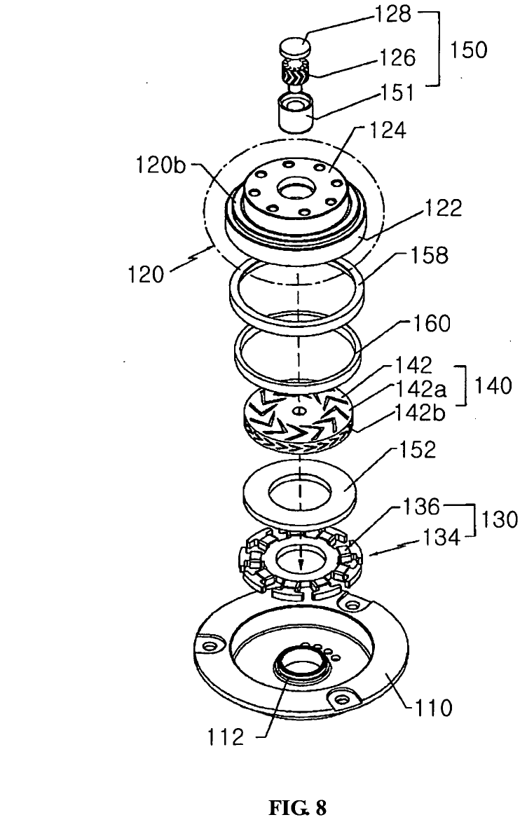

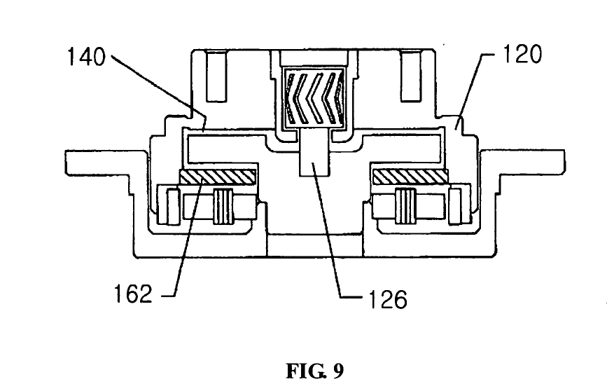

The present invention may be implemented in another embodiment. The third embodiment of the present invention will be described with reference to FIGS. 8 and 9.

In the third embodiment of the present invention, the same elements as the first embodiment of the present invention may be given the same reference numerals, and the detailed descriptions thereof will be omitted for a simplification.

FIG. 8 is a disassembled perspective view when a spindle shaft is fixed, and there is a bushing thrust in a hybrid bearing of a hard disk drive spindle motor according to a third embodiment of the present invention, and FIG. 9 is a cross sectional view when a spindle shaft is fixed, and there is a bushing thrust in a hybrid bearing of a hard disk drive spindle motor according to a third embodiment of the present invention. FIGS. 8 and 9 are views illustrating the construction that spindle shaft 126 is fixed to the bearing assembly 142, and the sleeve 151 is rotated together with the hub in a method that the sleeve 151 is fixed to the hub 120 according to the present invention.

The hybrid spindle motor 100 according to a third embodiment of the present invention includes a base 110 which forms a lower construction of the same, a hub 120 which includes a metallic circular platter (not shown) rotatably installed in an upper portion of the base 110, a stator 130 which includes a compression insertion hole in the center portion of the same and is implemented in such a manner that the coil 136 is wound on each of multiple cores 134 which are formed at a regular interval in an outer surface of the compression insertion hole, a fluid dynamic pressure bearing 150 formed in an upper portion of the hub 120, a spindle shaft 126 which supports the weight of the hub 120, a ring shaped permanent magnet 160k, a back yoke 158 which supports the permanent magnet 160, and a bushing thrust 162 between the bearing assembly 142 and the stator 130.

Here, since the constructions of the base 110, the hub 120, the stator 130, the aero dynamic pressure bearing 140, the fluid dynamic pressure bearing 150, and the permanent magnet 160 of the hybrid spindle motor 100 are the same as the construction of FIGS. 4 and 5 according to the first embodiment of the present invention, the detailed descriptions thereof will be omitted.

In addition, in the operation implemented based on the construction of the hybrid spindle motor 100 according to a third embodiment of the present invention, since the spindle motor 100 for the hard disk drive according to the third embodiment of the present invention has an accelerant rotation accuracy as shown in FIGS. 8 and 9, the detailed description thereof will be omitted.

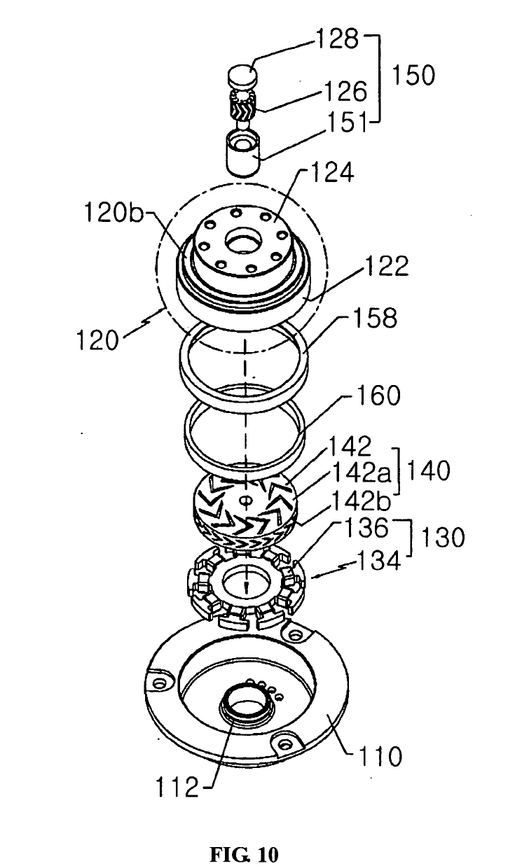

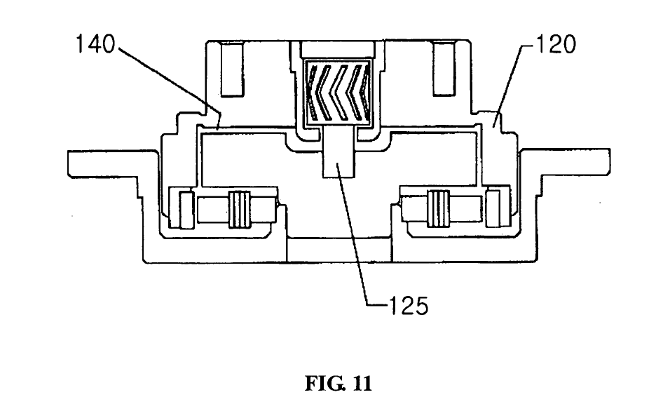

The present invention may be implemented in another embodiment of the present invention. The fourth embodiment of the present invention will be described with reference to FIGS. 10 and 11.

FIG. 10 is a disassembled perspective view when a spindle shaft is fixed in a hybrid bearing of a hard disk drive spindle motor according to a fourth embodiment of the present invention, and FIG. 11 is a cross sectional view when a spindle shaft is fixed in a hybrid bearing of a hard disk drive spindle motor according to a fourth embodiment of the present invention. FIGS. 10 and 11 are views illustrating the construction that the bushing thrust 162 is excluded from the construction of the third embodiment of the present invention.

The hybrid spindle motor 100 according to the fourth embodiment of the present invention includes a base 110 which forms a lower construction of the same, a hub 120 which includes a metallic circular platter (not shown) rotatably installed in an upper portion of the base 110, a stator 130 which is implemented in such a manner that a compression insertion hole is formed in a center portion of the same, and a coil 136 is wound on each of multiple cores 134 formed at a regular interval in an outer surface of the compression insertion hole, an aero dynamic pressure bearing 140, a fluid dynamic pressure bearing 150 which is formed in an upper portion of the hub 120, a spindle shaft 126 which supports the weight of the hub 120, a ring shaped permanent magnet 160, a back yoke 158 which supports the permanent magnet 160, a bearing assembly 142 and the stator 130.

Since the constructions of the base 110, the hub 120, the stator 130, the aero dynamic pressure bearing 140, the fluid dynamic pressure bearing 150, the permanent bearing 160, etc. of the hybrid spindle motor 100 are the same as the construction of FIGS. 4 and 5 according to the first embodiment of the present invention, the detailed description thereof will be omitted.

As shown in FIGS. 10 and 11, in the operation of the hybrid spindle motor 100 according to a fourth embodiment of the present invention, since it is possible to implement an excellent rotation accuracy in the spindle motor 100 for a hard disk drive according to the fourth embodiment of the present invention, as shown in FIGS. 4 and 5 a detailed description thereof will be omitted.

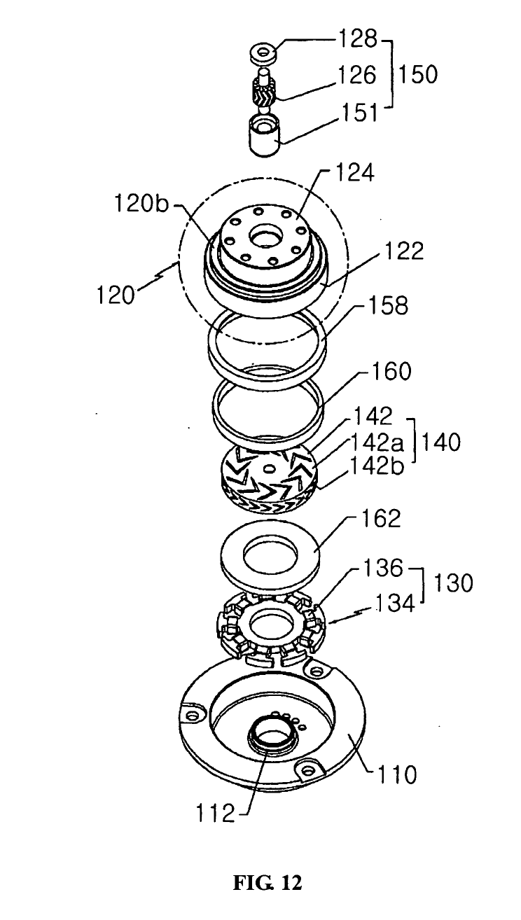

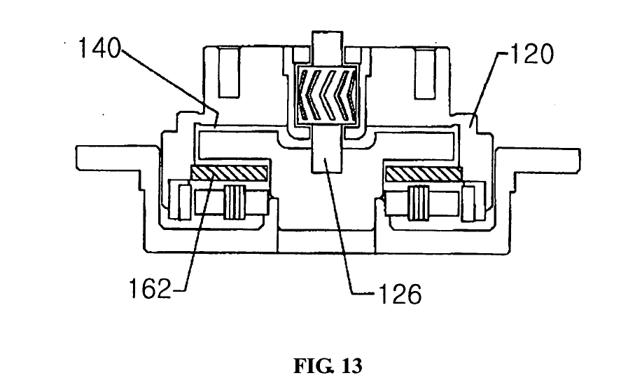

The present invention may be implemented based on another embodiment. The fifth embodiment of the present invention will be described with reference to FIGS. 12 and 13.

FIG. 12 is a disassembled perspective view when there is a bushing thrust, a spindle shaft is fixed to a bearing assembly and is extended to an outer portion of a hub in a hybrid bearing of a hard disk drive spindle motor according to a fifth embodiment of the present invention, and FIG. 13 is a cross sectional view when there is a bushing thrust, a spindle shaft is fixed to a bearing assembly and is extended to an outer portion of a hub in a hybrid bearing of a hard disk drive spindle motor according to a fifth embodiment of the present invention. FIGS. 12 and 13 are view illustrating the constructions which are the same as the third embodiment of the present invention except for the construction that the spindle shaft 126 of the present invention is extended.

The hybrid spindle motor according to a fifth embodiment of the present invention includes a base 110 which forms a lower construction of the same, a hub 120 which includes a metallic circular platter (not shown) which is rotatably installed in an upper portion of the base 110, a stator 130 which has a compression insertion hole in a center portion of the same and is implemented in such a manner that a coil 136 is wound on each of multiple cores 134 formed in an outer surface of the compression insertion hole at a regular interval, an aero dynamic pressure bearing 140, a fluid dynamic pressure bearing 150 formed in an upper portion of the hub 120, a ring shaped permanent magnet 160, a back yoke 158 which supports the permanent magnet 160, and a bushing thrust 162 provided between the bearing member 142 and the stator 130.

Here, since the constructions of the base 110, the hub 120, the stator 130, the aero dynamic pressure bearing 140, the fluid dynamic pressure bearing 150, the permanent bearing 160, etc. of the hybrid spindle motor 100 are the same as the construction of FIGS. 4 and 5 according to the first embodiment of the present invention, the detailed description thereof will be omitted.

As shown in FIGS. 12 and 13, in the operation of the hybrid spindle motor 100 according to a fifth embodiment of the present invention, since it is possible to implement an excellent rotation accuracy in the spindle motor 100 for a hard disk drive according to the fifth embodiment of the present invention, as shown in FIGS. 4 and 5 a detailed description thereof will be omitted.

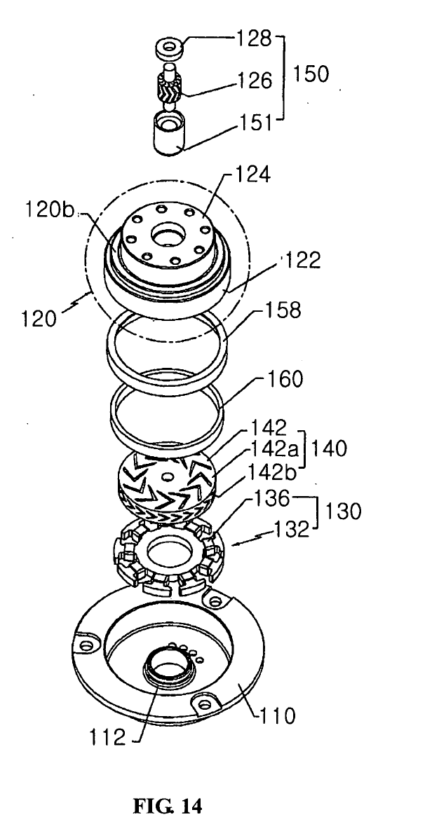

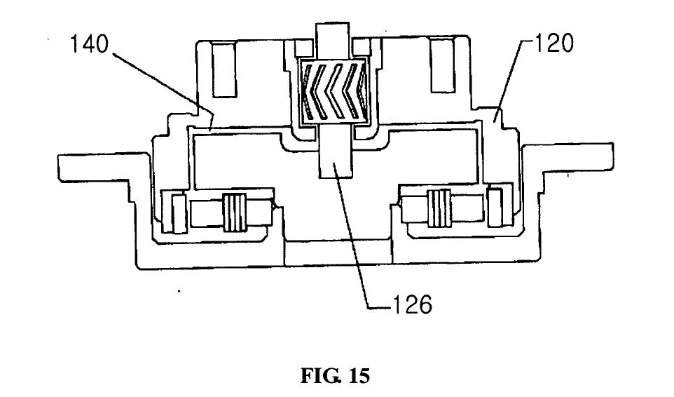

The present invention may be implemented based on another embodiment. The sixth embodiment of the present invention will be described with reference to FIGS. 14 and 15.

FIG. 14 is a disassembled perspective view when a spindle shaft is fixed to a bearing assembly and is extended in a direction of an outer portion of a hub in a hybrid bearing of a hard disk drive spindle motor according to a sixth embodiment of the present invention, and FIG. 15 is a cross sectional view when a spindle shaft is fixed to a bearing assembly and is extended in a direction of an outer portion of a hub in a hybrid bearing of a hard disk drive spindle motor according to a sixth embodiment of the present invention. FIGS. 14 and 15 are views illustrating the same construction as the construction of FIGS. 10 and 11 except for the construction that the spindle shaft 126 of the present invention is extended.

The hybrid spindle motor according to a sixth embodiment of the present invention includes a base 110 which forms a lower construction of the same, a hub 120 which includes a metallic circular platter (not shown) which is rotatably installed in an upper portion of the base 110, a stator 130 which has a compression insertion hole in a center portion of the same and is implemented in such a manner that a coil 136 is wound on each of multiple cores 134 formed in an outer surface of the compression insertion hole at a regular interval, an aero dynamic pressure bearing 140, a fluid dynamic pressure bearing 150 formed in an upper portion of the hub 120, a ring shaped permanent magnet 160, a back yoke 158 which supports the permanent magnet 160, a bearing assembly 142 and the stator 130.

Here, since the constructions of the base 110, the hub 120, the stator 130, the aero dynamic pressure bearing 140, the fluid dynamic pressure bearing 150, the permanent bearing 160, etc. of the hybrid spindle motor 100 are the same as the construction of FIGS. 4 and 5 according to the first embodiment of the present invention, the detailed description thereof will be omitted.

As shown in FIGS. 14 and 15, in the operation of the hybrid spindle motor 100 according to a sixth embodiment of the present invention, since it is possible to implement an excellent rotation accuracy in the spindle motor 100 for a hard disk drive according to the sixth embodiment of the present invention, as shown in FIGS. 4 and 5 a detailed description thereof will be omitted.

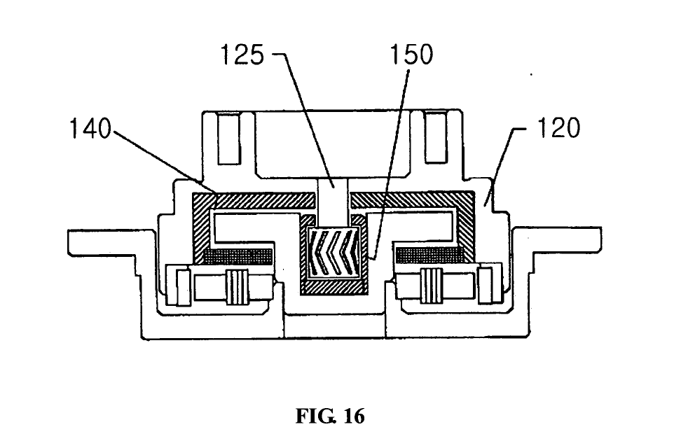

The present invention may be implemented based on another embodiment. The seventh embodiment of the present invention will be described with reference to FIG. 16.

FIG. 16 is a cross sectional view when an aero dynamic pressure bearing and a fluid dynamic pressure bearing are separately fabricated and then are assembled to a hub and a bearing assembly in a hybrid bearing of a hard disk drive spindle motor according to a seventh embodiment of the present invention. In the hybrid spindle motor of FIG. 16 according to the seventh embodiment of the present invention, the spindle shaft 126 of the hub 120 and the casing 150 of FIG. 16 are fabricated in a module type.

The hybrid spindle motor according to a seventh embodiment of the present invention includes a base 110 which forms a lower construction of the same, a hub 120 which includes a metallic circular platter (not shown) which is rotatably installed in an upper portion of the base 110, a stator 130 which has a compression insertion hole in a center portion of the same and is implemented in such a manner that a coil 136 is wound on each of multiple cores 134 formed in an outer surface of the compression insertion hole at a regular interval, an aero dynamic pressure bearing 140, a fluid dynamic pressure bearing 150 formed in an upper portion of the hub 120, a spindle shaft 126 which supports the weight of the hub 120, a ring shaped permanent magnet 160, a back yoke 158 which supports the permanent magnet 160, and a bushing thrust 162 provided between the bearing assembly 142 and the stator 130.

Here, since the constructions of the base 110, the hub 120, the stator 130, the aero dynamic pressure bearing 140, the fluid dynamic pressure bearing 150, the permanent bearing 160, etc. of the hybrid spindle motor 100 are the same as the construction of FIGS. 4 and 5 according to the first embodiment of the present invention, the detailed description thereof will be omitted.

As shown in FIG. 16, in the operation of the hybrid spindle motor 100 according to a seventh embodiment of the present invention, since it is possible to implement an excellent rotation accuracy in the spindle motor 100 for a hard disk drive according to the seventh embodiment of the present invention, as shown in FIGS. 4 and 5 a detailed description thereof will be omitted.

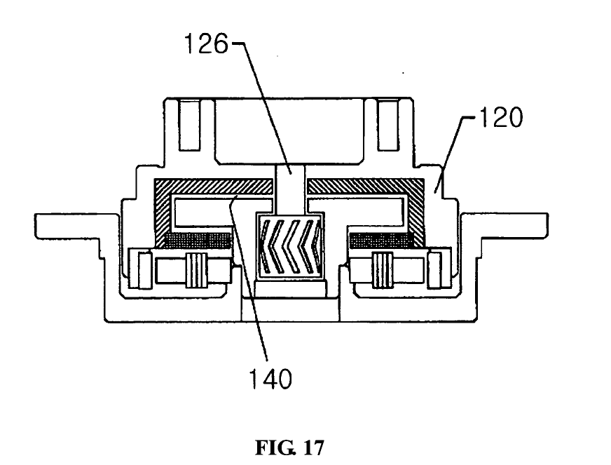

The present invention may be implemented based on another embodiment. The eighth embodiment of the present invention will be described with reference to FIG. 17.

FIG. 17 is a cross sectional view illustrating a hybrid spindle motor according to an eighth embodiment of the present invention. As shown therein, the aero dynamic pressure bearing 140 is integrally formed with the hub 120, and the sleeve 151 operates as a bearing assembly 151 of the aero dynamic pressure bearing 150.

The hybrid spindle motor 100 according to an eighth embodiment of the present invention includes a base 110 which forms a lower construction of the same, a hub 120 which includes a metallic circular platter (not shown) which is rotatably installed in an upper portion of the base 110, a stator 130 which has a compression insertion hole in a center portion of the same and is implemented in such a manner that a coil 136 is wound on each of multiple cores 134 formed in an outer surface of the compression insertion hole at a regular interval, an aero dynamic pressure bearing 140, a fluid dynamic pressure bearing 150 formed in an upper portion of the hub 120, a spindle shaft 126 which supports the weight of the hub 120, a ring shaped permanent magnet 160, a back yoke 158 which supports the permanent magnet 160, and a bushing thrust 162 provided between the bearing assembly 142 and the stator 130.

Here, since the constructions of the base 110, the hub 120, the stator 130, the aero dynamic pressure bearing 140, the fluid dynamic pressure bearing 150, the permanent bearing 160, etc. of the hybrid spindle motor 100 are the same as the construction of FIGS. 4 and 5 according to the first embodiment of the present invention, the detailed description thereof will be omitted.

As shown in FIG. 17, in the operation of the hybrid spindle motor 100 according to an eighth embodiment of the present invention, since it is possible to implement an excellent rotation accuracy in the spindle motor 100 for a hard disk drive according to the eighth embodiment of the present invention, as shown in FIGS. 4 and 5 a detailed description thereof will be omitted.

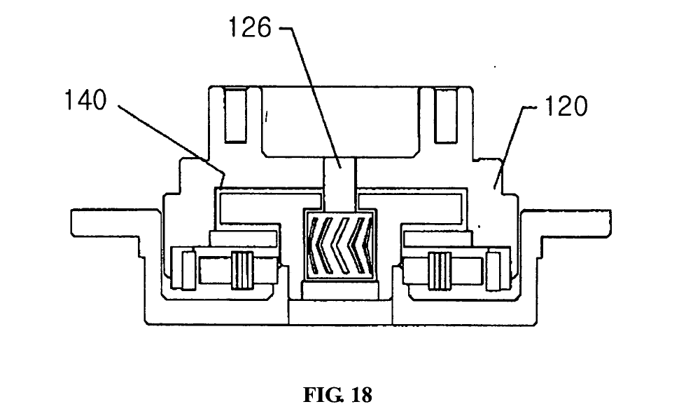

The present invention may be implemented based on another embodiment. The ninth embodiment of the present invention will be described with reference to FIG. 18.

FIG. 18 is a cross sectional view illustratging the hybrid spindle motor according to a ninth embodiment of the present invention. As shown in FIG. 18, the aero dynamic pressure bearing 140 is separately assembled, and the sleeve 151 operates as the bearing assembly 151 of the aero dynamic pressure bearing 150. In the hybrid spindle motor according to the eighth embodiment of the present invention, the hybrid spindle motor is implemented using the spindle shaft 126, and the sleeve 161 of FIG. 16 is removed, and the aero dynamic pressure bearing 140 is integrally fabricated. Therefore, the number of elements is decreased.

The hybrid spindle motor 100 according to a ninth embodiment of the present invention includes a base 110 which forms a lower construction of the same, a hub 120 which includes a metallic circular platter (not shown) which is rotatably installed in an upper portion of the base 110, a stator 130 which has a compression insertion hole in a center portion of the same and is implemented in such a manner that a coil 136 is wound on each of multiple cores 134 formed in an outer surface of the compression insertion hole at a regular interval, an aero dynamic pressure bearing 140, a fluid dynamic pressure bearing 150 formed in an upper portion of the hub 120, a spindle shaft 126 which supports the weight of the hub 120, a ring shaped permanent magnet 160, a back yoke 158 which supports the permanent magnet 160, and a bushing thrust 162 provided between the bearing assembly 142 and the stator 130.

Here, since the constructions of the base 110, the hub 120, the stator 130, the aero dynamic pressure bearing 140, the fluid dynamic pressure bearing 150, the permanent bearing 160, etc. of the hybrid spindle motor 100 are the same as the construction of FIGS. 4 and 5 according to the first embodiment of the present invention, the detailed description thereof will be omitted.

As shown in FIG. 18, in the operation of the hybrid spindle motor 100 according to a ninth embodiment of the present invention, since it is possible to implement an excellent rotation accuracy in the spindle motor 100 for a hard disk drive according to the ninth embodiment of the present invention, as shown in FIGS. 4 and 5 a detailed description thereof will be omitted.

As described above, according to the spindle motor for a hard disk drive according to the present invention, the spindle motor is supported in the radial direction and thrust direction based on the fluid dynamic pressure bearing which directly contacts with the center of the hub. The aero dynamic pressure bearing having an air groove therein receives the loads in the radial and thrust directions of the hub based on a non-contact method, so that it is possible to prevent a mechanical contact which may be a cause of a noise and operation error of the aero dynamic pressure bearing when the spindle motor is operated or is stopped. In addition, since the static electricity which occurs when the hub or platter makes a friction with the air is capable of forming a discharging path of the static electricity based on the fluid dynamic pressure bearing, it is possible to present the stored data from being lost due to the static electricity. In addition, it is possible to prevent a friction heat of a fluid dynamic pressure bearing due to a fast heat transfer through the aero dynamic pressure bearing and a gas discharge due to the friction heat, so that a stable and excellent rotation state are implemented.

According to the spindle motor for a hard disk drive(HDD) according to the present invention, it is possible to implement a desired rotation strength of a bearing with respect to an external impact during a high speed rotation and to prevent a hub from being rotated in an inclined state for thereby implementing an excellent rotation accuracy by combining a rotation support structure of a contact method based on a fluid dynamic pressure bearing having a groove formed in at least more than one portion among the spindle shaft, the sleeve, and the thrust plate, and the aero dynamic pressure bearing which is formed in at least one portion among the upper horizontal surface of the bearing assembly of the aero dynamic pressure bearing, the lower horizontal surface, the outer surface of the bearing assembly, the lower horizontal surface of the hub, the inner surface of the lower side of the integral body of the hub, and the inner surface of the bushing thrust.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. In a spindle motor for a hard disk drive (HDD), an aero and fluid hybrid dynamic pressure bearing of a spindle motor, comprising: an aero dynamic pressure bearing which is formed in a structure that there are provided a disk shaped bearing assembly, and a certain pore surrounding the bearing assembly and which includes a plurality of grooves and forms an air layer having a certain strength so that an air flow supports a load between a hub and the bearing assembly after the hub is operated; and a fluid dynamic pressure bearing which is formed in a structure that a plurality of grooves are formed in at least one surface among a spindle shaft, a sleeve surrounding the spindle shaft, and a thrust plate and which has a pore formed between the spindle shaft and the sleeve for rotatably supporting the hub and filled with a certain fluid.

2. The bearing of claim 1, wherein a groove is formed in at least one among an upper horizontal surface of the bearing assembly, a lower horizontal surface of the bearing assembly, and an outer surface of the bearing assembly.

3. The bearing of claim 1, wherein said fluid has a certain viscosity and forms a discharging path of a static electricity.

4. The bearing of claim 1, wherein said hub has a groove in at least one among a lower portion of the hub, an inner surface of the hub and an inner surface of the bushing thrust.

5. The bearing of claim 1, wherein said spindle shaft includes a spindle shaft formed in a spherical shape, a semi-circular shape, a conical shape or a cylindrical shape.

6. The bearing of claim 1, wherein in said spindle shaft, a bearing assembly of the aero dynamic pressure bearing does not make a mechanical friction with a hub which is an opponent element when the hub is operated or is stopped.

7. The bearing of claim 1, wherein said fluid dynamic pressure bearing is rotated with respect to a hub shaft which passes through the interior of the same in a vertical direction.

8. The bearing of claim 1, wherein said fluid dynamic pressure bearing forms a fluid dynamic pressure between the fluid dynamic pressure bearing assembly and the spindle shaft.

9. In a spindle motor for a hard disk drive which includes a base which forms a lower construction, a hub which is rotatably installed in an upper portion of the base and fixes a platter in an upper surface, and has a permanent magnet in an inner lower surface, and a stator which has a plurality of teeth having a coil wound thereon and protruded in a direction of an outer surface for thereby forming a radial construction, a fluid and air hybrid dynamic pressure bearing, comprising:
an aero dynamic pressure bearing which is formed in a structure that there are provided a disk shaped bearing assembly, and a certain pore surrounding the bearing assembly and which includes a plurality of grooves and forms an air layer having a certain strength so that an air flow supports a load between a hub and the bearing assembly after the hub is operated;
a fluid dynamic pressure bearing which is formed in a structure that a plurality of grooves are formed in at least one surface among a spindle shaft, a sleeve surrounding the spindle shaft, and a thrust plate and which has a pore formed between the spindle shaft and the sleeve for rotatably supporting the hub and filled with a certain fluid; and
a bushing thrust provided between the fluid dynamic pressure bearing, a ring shaped permanent magnet, a back yoke which supports the permanent magnet, a bearing assembly of the aero dynamic pressure bearing and the stator.

10. The bearing of claim 9, wherein said hub includes a fluid dynamic pressure bearing in the interior of the same and is rotatably installed in an upper portion of the base.

11. The bearing of claim 9, wherein said groove is provided by at least one.

12. The bearing of claim 9, wherein said fluid has a certain viscosity and forms a discharging path of a static electricity.

13. The bearing of claim 9, wherein said hub has a groove in at least one among a lower portion of the hub, an inner surface of the hub and an inner surface of the bushing thrust.

14. The bearing of claim 9, wherein said spindle shaft includes a spindle shaft formed in a spherical shape, a semi-circular shape, a conical shape or a cylindrical shape.

15. The bearing of claim 9, wherein said fluid dynamic pressure bearing is rotated with respect to the spindle shaft positioned in the interior.

16. The bearing of claim 9, wherein in said fluid dynamic pressure bearing, a fluid dynamic pressure is formed between the sleeve and the spindle shaft.

17. The bearing of claim 9, wherein the center of the fluid dynamic pressure bearing is supported in a radial direction and a thrust direction.

18. The bearing of claim 9, wherein said aero dynamic pressure bearing is installed in a space formed by the aero dynamic pressure bearing assembly and the hub for thereby forming an aero dynamic pressure between the hub and the aero dynamic pressure bearing assembly when the hub is rotated.

19. The bearing of claim 9, wherein said aero dynamic pressure bearing is installed in A lower portion of the hub distanced from the fluid dynamic pressure bearing in an inner surface for thereby receiving a thrust and radial direction load based on a non-contact method.

20. In a spindle motor for a hard disk drive which includes a base which forms a lower construction, a hub which is rotatably installed in an upper portion of the base and fixes a platter in an upper surface, and has a permanent magnet in an inner lower surface, and a stator which has a plurality of teeth having a coil wound thereon and protruded in a direction of an outer surface for thereby forming a radial construction, a fluid and air hybrid dynamic pressure bearing, comprising:
an aero dynamic pressure bearing which is formed in a structure that there are provided a disk shaped bearing assembly, and a certain pore surrounding the bearing assembly and which includes a plurality of grooves and forms an air layer having a certain strength so that an air flow supports a load between a hub and the bearing assembly after the hub is operated;
a fluid dynamic pressure bearing which is implemented in a structure that a plurality of grooves are formed in at least one surface in the spindle shaft, a sleeve surrounding the same, and a thrust plate, and a certain fluid for a discharging path of a static electricity is filled in a pore formed between the spindle shaft and the sleeve for rotatably supporting the hub and forming a fluid dynamic pressure between the spindle shaft; and
a bushing thrust which is implemented in a structure that the fluid dynamic pressure bearing is fixed with respect to the spindle shaft formed in an upper portion of the hub and in which the fluid dynamic pressure bearing is fixed about the hub shaft which passes through one end formed in a vertical direction of the interior, said busing thrust being provided between the ring shaped permanent magnet, a back yoke supporting the permanent magnet, a bearing assembly of the aero dynamic pressure bearing and the stator.

21. The bearing of claim 20, wherein said groove is provided by more than at least one.

22. The bearing of claim 20, wherein said hub has a groove in at least one among a lower portion of the hub, an inner surface of the hub and an inner surface of the bushing thrust.

23. The bearing of claim 20, wherein said spindle shaft includes a spindle shaft formed in a spherical shape, a semi-circular shape, a conical shape or a cylindrical shape.

24. The bearing of claim 20, wherein said aero dynamic pressure bearing is installed in a space formed by the aero dynamic pressure bearing assembly and the hub, and an aero dynamic pressure is formed between the hub and the aero dynamic pressure bearing assembly when the hub is rotated.

25. The bearing of claim 20, wherein said aero dynamic pressure bearing is installed in a lower portion of the hub distanced from the fluid dynamic pressure bearing in an inner surface and receives a thrust and radial direction load based on a non-contact method.

26. In a spindle motor for a hard disk drive which includes a base which forms a lower construction, a hub which is rotatably installed in an upper portion of the base and fixes a platter in an upper surface, and has a permanent magnet in an inner lower surface, and a stator which has a plurality of teeth having a coil wound thereon and protruded in a direction of an outer surface for thereby forming a radial construction, a fluid and air hybrid dynamic pressure bearing, comprising:
an aero dynamic pressure bearing which is formed in a structure that there are provided a disk shaped bearing assembly, and a certain pore surrounding the bearing assembly and which includes a plurality of grooves and forms an air layer having a certain strength so that an air flow supports a load between a hub and the bearing assembly after the hub is operated;
a fluid dynamic pressure bearing which is implemented in a structure that a plurality of grooves are formed in at least one surface in the spindle shaft, a sleeve surrounding the same, and a thrust plate, and a certain fluid for a discharging path of a static electricity is filled in a pore formed between the spindle shaft and the sleeve for rotatably supporting the hub and forming a fluid dynamic pressure between the spindle shaft; and
a bushing thrust which is implemented in a structure that the fluid dynamic pressure bearing is fixed with respect to the spindle shaft formed in an upper portion of the hub and in which the fluid dynamic pressure bearing is fixed about the hub shaft which passes through one end formed in a vertical direction of the interior, said busing thrust being provided between the ring shaped permanent magnet, a back yoke supporting the permanent magnet, a bearing assembly of the aero dynamic pressure bearing and the stator, wherein the sleeve is fixed to the hub, and the spindle shaft is fixed to the bearing assembly, and the sleeve is rotated together with the hub.

27. In a spindle motor for a hard disk drive which includes a base which forms a lower construction, a hub which is rotatably installed in an upper portion of the base and fixes a platter in an upper surface, and has a permanent magnet in an inner lower surface, and a stator which has a plurality of teeth having a coil wound thereon and protruded in a direction of an outer surface for thereby forming a radial construction, a fluid and air hybrid dynamic pressure bearing, comprising:
an aero dynamic pressure bearing which is formed in a structure that there are provided a disk shaped bearing assembly, and a certain pore surrounding the bearing assembly and which includes a plurality of grooves and forms an air layer having a certain strength so that an air flow supports a load between a hub and the bearing assembly after the hub is operated;
a fluid dynamic pressure bearing which is implemented in a structure that a plurality of grooves are formed in at least one surface in the spindle shaft, a sleeve surrounding the same, and a thrust plate, and a certain fluid for a discharging path of a static electricity is filled in a pore formed between the spindle shaft and the sleeve for rotatably supporting the hub and forming a fluid dynamic pressure between the spindle shaft; and
a bushing thrust which is implemented in a structure that the fluid dynamic pressure bearing is fixed with respect to the spindle shaft formed in an upper portion of the hub and in which the fluid dynamic pressure bearing is fixed about the hub shaft which passes through one end formed in a vertical direction of the interior, said busing thrust being provided between the ring shaped permanent magnet, a back yoke supporting the permanent magnet, a bearing assembly of the aero dynamic pressure bearing and the stator, wherein the sleeve is fixed to the hub, and the spindle shaft which is downwardly extended is fixed to the bearing assembly, and the sleeve is rotated together with the hub.

28. In a spindle motor for a hard disk drive which includes a base which forms a lower construction, a hub which is rotatably installed in an upper portion of the base and fixes a platter in an upper surface, and has a permanent magnet in an inner lower surface, and a stator which has a plurality of teeth having a coil wound thereon and protruded in a direction of an outer surface for thereby forming a radial construction, a fluid and air hybrid dynamic pressure bearing, comprising:
an aero dynamic pressure bearing which is formed in a structure that there are provided a disk shaped bearing assembly, and a certain pore surrounding the bearing assembly and which includes a plurality of grooves and forms an air layer having a certain strength so that an air flow supports a load between a hub and the bearing assembly after the hub is operated;
a fluid dynamic pressure bearing which is implemented in a structure that a plurality of grooves are formed in at least one surface in the spindle shaft, a sleeve surrounding the same, and a thrust plate, and a certain fluid for a discharging path of a static electricity is filled in a pore formed between the spindle shaft and the sleeve for rotatably supporting the hub and forming a fluid dynamic pressure between the spindle shaft; and
a bushing thrust which is implemented in a structure that the fluid dynamic pressure bearing is fixed with respect to the spindle shaft formed in an upper portion of the hub and in which the fluid dynamic pressure bearing is fixed about the hub shaft which passes through one end formed in a vertical direction of the interior, said busing thrust being provided between the ring shaped permanent magnet, a back yoke supporting the permanent magnet, a bearing assembly of the aero dynamic pressure bearing and the stator, wherein the sleeve is fixed to the hub, and the spindle shaft which is upwardly and downwardly extended is fixed to the bearing assembly, and the sleeve is rotated together with the hub.

29. In a spindle motor for a hard disk drive which includes a base which forms a lower construction, a hub which is rotatably installed in an upper portion of the base and fixes a platter in an upper surface, and has a permanent magnet in an inner lower surface, and a stator which has a plurality of teeth having a coil wound thereon and protruded in a direction of an outer surface for thereby forming a radial construction, a fluid and air hybrid dynamic pressure bearing, comprising:
an aero dynamic pressure bearing which is formed in a structure that there are provided a disk shaped bearing assembly, and a certain pore surrounding the bearing assembly and which includes a plurality of grooves and forms an air layer having a certain strength so that an air flow supports a load between a hub and the bearing assembly after the hub is operated;
a fluid dynamic pressure bearing which is implemented in a structure that a plurality of grooves are formed in at least one surface in the spindle shaft, a sleeve surrounding the same, and a thrust plate, and a certain fluid for a discharging path of a static electricity is filled in a pore formed between the spindle shaft and the sleeve for rotatably supporting the hub and forming a fluid dynamic pressure between the spindle shaft; and
a structure that the fluid dynamic pressure bearing is fixed with respect to the spindle shaft formed in an upper portion of the hub, and the fluid dynamic pressure bearing is fixed about the hub shaft which passes through one end formed in a vertical direction of the interior, and there are provided a ring shaped permanent magnet, and a back yoke which support the permanent magnet, wherein the sleeve is fixed to the hub, and the spindle shaft which is upwardly and downwardly extended is fixed to the bearing assembly, and the sleeve is rotated together with the hub.

30. In a spindle motor for a hard disk drive which includes a base which forms a lower construction, a hub which is rotatably installed in an upper portion of the base and fixes a platter in an upper surface, and has a permanent magnet in an inner lower surface, and a stator which has a plurality of teeth having a coil wound thereon and protruded in a direction of an outer surface for thereby forming a radial construction, a fluid and air hybrid dynamic pressure bearing, comprising:
an aero dynamic pressure bearing which is formed in a structure that there are provided a disk shaped bearing assembly, and a certain pore surrounding the bearing assembly and which includes a plurality of grooves and forms an air layer having a certain strength so that an air flow supports a load between a hub and the bearing assembly after the hub is operated;
a fluid dynamic pressure bearing which is implemented in a structure that a plurality of grooves are formed in at least one surface in the spindle shaft, a sleeve surrounding the same, and a thrust plate, and a certain fluid for a discharging path of a static electricity is filled in a pore formed between the spindle shaft and the sleeve for rotatably supporting the hub and forming a fluid dynamic pressure between the spindle shaft; and
a structure that the fluid dynamic pressure bearing is fixed with respect to the spindle shaft formed in an upper portion of the hub, and the fluid dynamic pressure bearing is fixed about the hub shaft which passes through one end formed in a vertical direction of the interior, and there are provided a ring shaped permanent magnet, and a back yoke which support the permanent magnet, wherein the aero dynamic pressure bearing and the fluid dynamic pressure bearing are assembled or disassembled.

31. In a spindle motor for a hard disk drive which includes a base which forms a lower construction, a hub which is rotatably installed in an upper portion of the base and fixes a platter in an upper surface, and has a permanent magnet in an inner lower surface, and a stator which has a plurality of teeth having a coil wound thereon and protruded in a direction of an outer surface for thereby forming a radial construction, a fluid and air hybrid dynamic pressure bearing, comprising:
an aero dynamic pressure bearing which is formed in a structure that there are provided a disk shaped bearing assembly, and a certain pore surrounding the bearing assembly and which includes a plurality of grooves and forms an air layer having a certain strength so that an air flow supports a load between a hub and the bearing assembly after the hub is operated;
a fluid dynamic pressure bearing which is implemented in a structure that a plurality of grooves are formed in at least one surface in the spindle shaft, a sleeve surrounding the same, and a thrust plate, and a certain fluid for a discharging path of a static electricity is filled in a pore formed between the spindle shaft and the sleeve for rotatably supporting the hub and forming a fluid dynamic pressure between the spindle shaft; and
a bushing thrust which is implemented in a structure that the fluid dynamic pressure bearing is fixed with respect to the spindle shaft formed in an upper portion of the hub and in which the fluid dynamic pressure bearing is fixed about the hub shaft which passes through one end formed in a vertical direction of the interior, said busing thrust being provided between the ring shaped permanent magnet, a back yoke supporting the permanent magnet, a bearing assembly of the aero dynamic pressure bearing and the stator, wherein said hub is integrally formed with the aero dynamic pressure bearing, and the aero dynamic pressure bearing is fixed to the sleeve.

32. In a spindle motor for a hard disk drive which includes a base which forms a lower construction, a hub which is rotatably installed in an upper portion of the base and fixes a platter in an upper surface, and has a permanent magnet in an inner lower surface, and a stator which has a plurality of teeth having a coil wound thereon and protruded in a direction of an outer surface for thereby forming a radial construction, a fluid and air hybrid dynamic pressure bearing, comprising:
an aero dynamic pressure bearing which is formed in a structure that there are provided a disk shaped bearing assembly, and a certain pore surrounding the bearing assembly and which includes a plurality of grooves and forms an air layer having a certain strength so that an air flow supports a load between a hub and the bearing assembly after the hub is operated;
a fluid dynamic pressure bearing which is implemented in a structure that a plurality of grooves are formed in at least one surface in the spindle shaft, a sleeve surrounding the same, and a thrust plate, and a certain fluid for a discharging path of a static electricity is filled in a pore formed between the spindle shaft and the sleeve for rotatably supporting the hub and forming a fluid dynamic pressure between the spindle shaft; and
a bushing thrust which is implemented in a structure that the fluid dynamic pressure bearing is fixed with respect to the spindle shaft formed in an upper portion of the hub and in which the fluid dynamic pressure bearing is fixed about the hub shaft which passes through one end formed in a vertical direction of the interior, said busing thrust being provided between the ring shaped permanent magnet, a back yoke supporting the permanent magnet, a bearing assembly of the aero dynamic pressure bearing and the stator, wherein said aero dynamic pressure bearing is separately assembled, and the aero dynamic pressure bearing is fixed to the sleeve.

33. In a bearing of a spindle motor for a hard disk drive which includes a base which forms a lower construction, a hub which is rotatably installed in an upper portion of the base and fixes a platter, and a stator in which a plurality of teeth each having a coil are protruded in a direction of an outer surface in a radial shape, a hybrid dynamic pressure bearing of a spindle motor, comprising:
an aero dynamic pressure bearing which includes a bearing assembly formed in a disk shape and forming an upper construction, and a support member which is integrally formed with a lower portion of the bearing assembly and is compression-fixed to the base and which is installed in a space formed by the base and the hub;
an aero dynamic pressure bearing which forms an air layer having a certain strength for supporting a load of an air flow between the hub and the bearing assembly after the hub is operated, in such a manner that a groove is formed in at least one surface among an upper horizontal surface and a lower horizontal surface of the bearing assembly of the aero dynamic pressure bearing, a lower horizontal surface of the hub, an integral inner surface of the hub, and an inner surface of the bushing thrust; and
a fluid dynamic pressure bearing which obtains a static electricity path by filling a certain fluid such as an oil having a certain viscosity with respect to a static electricity generated in a peripheral portion of the hub and platter and which has an inner construction of a spherical shape, a semi-circular shape, a conical shape or a cylindrical shape, said fluid dynamic pressure bearing supporting the center of the hub in the radial direction and thrust direction.

34. In a spindle motor for a hard disk drive which includes a base which forms a lower construction, a hub which is rotatably installed in an upper portion of the base and fixes a platter in an upper surface, and has a permanent magnet in an inner lower surface, and a stator which has a plurality of teeth having a coil wound thereon and protruded in a direction of an outer surface for thereby forming a radial construction, a fluid and air hybrid dynamic pressure bearing, comprising:
an aero dynamic pressure bearing which is formed in a structure that there are provided a disk shaped bearing assembly, and a certain pore surrounding the bearing assembly and which includes a plurality of grooves and forms an air layer having a certain strength so that an air flow supports a load between a hub and the bearing assembly after the hub is operated;
a fluid dynamic pressure bearing which is implemented in a structure that a plurality of grooves are formed in at least one surface among a spindle shaft, a sleeve surrounding the spindle shaft, and a thrust plate, wherein rotation and support point are fixed at a center which passes through the interior in a vertical direction, and a fluid for a discharging path of a static electricity is filled in a port formed between the spindle shaft and the sleeve for rotatably supporting the hub and forming a fluid dynamic pressure between the spindle shaft; and
a bushing thrust which is implemented in a structure that the fluid dynamic pressure bearing is fixed with respect to the spindle shaft formed in an upper portion of the hub and in which the fluid dynamic pressure bearing is fixed about the hub shaft which passes through one end formed in a vertical direction of the interior, said busing thrust being provided between the ring shaped permanent magnet, a back yoke supporting the permanent magnet, a bearing assembly of the aero dynamic pressure bearing and the stator.
